(19) United States
(12) Patent Application Publication
(10) Pub. No.: US 2002/0156641 A1
(43) Pub. Date: Oct. 24, 2002

(54) Service brokering apparatus, service brokering method, and service brokering program

(75) Inventor: Hironobu Kitajima, Kawasaki-shi (JP)

Correspondence Address: STAAS & HALSEY LLP, 700 11TH STREET, NW, SUITE 500, WASHINGTON, DC, 20001, US

(73) Assignee: Fujitsu Limited, Kawasaki (JP)

(21) Appl. No.: 09/939,722

(22) Filed: Aug. 28, 2001

(30) Foreign Application Priority Data
Feb. 14, 2001 (JP) 2001-36806

(51) Int. Cl. G06F 17/60

(52) U.S. Cl. 705/1; 705/5; 705/6

(57) ABSTRACT

A service brokering apparatus which can easily build a service integration system that provides a complex service by integrating a plurality of elementary services realized on computers. This apparatus achieves a system that can easily adapt itself to expanding or changing the services. The service brokering apparatus includes a storage device that stores service description information for each elementary service, the service description information having a combination of identification information of elementary service entities, declarative description information on information needed to realize the elementary services, and declarative description information on processing results of the elementary services. Further, the service brokering apparatus includes a transmitter/receiver for transmitting and receiving messages, and a device decomposing the complex service into the elementary services using the service description information upon receipt of a request message for the complex service from the outside, and generating an elementary service request plan having strings of combinations of at least elementary service request information needed to realize the complex service, and identification information of elementary service entities.

### CROSS-REFERENCE TO RELATED APPLICATION

This application is based upon and claims priority of Japanese Patent Application No. 2001-036806 filed Feb. 14, 2001, the content being incorporated herein by reference.

### BACKGROUND OF THE INVENTION

1. Field of the Invention

The present invention relates to a service brokering apparatus for implementing a service integration system that provides multiple services by integrating a plurality of elementary services on a computer. Such a system can be applied to a wide range of fields, such as overall EC (electronic commerce) activities, EAI (enterprise application integration) and EIP (enterprise information portal).

2. Description of the Prior Art

A system that integrates a plurality of information services on a computer system for providing some kind of information so as to make look like a single virtual information source to users is widely known as a typical application of software agents. Among such systems, those for integrating a plurality of relational data bases, or integrating a plurality of document search engines are also known.

Most virtual integration systems of these types use a brokering system for integrating a plurality of information sources. These brokering systems often have such a construction that the brokering system retains declarative descriptions of information contents that can be provided by the information sources, and upon receipt of an inquiry from a user, judges which information source can answer that inquiry, and then transfers the inquiry to that information source.

Conventional complex services as described above have been limited to the virtual integration of a plurality of information sources, and therefore have not been able to apply to the integration of more general services that are not limited to information services.

In order to build a travel reservation system by integrating two different services provided by existing flight reservation and hotel reservation systems, for example, it is necessary to prepare a brokering system having inherent interfaces with each of the existing flight reservation and hotel reservation systems. For this reason, there has heretofore been a high cost involved to develop such a brokering system to implement such a complex service.

Furthermore, when adding new elementary services to the complex service, or changing the service contents of the existing elementary services, it has been necessary to rebuild the brokering system, so problems making it difficult to expand or change the complex service have been caused. More specifically, when there is a need to add a new rent-a-car reservation service to the aforementioned travel reservation system, it has been necessary to incorporate in the brokering system an inherent interface with the existing rent-a-car reservation system that provides a rent-a-car reservation service. This has necessitated a substantial change in the program of the brokering system.

### SUMMARY OF THE INVENTION

The present invention is intended to solve the abovementioned problems. It is an object of the present invention to easily build a service integration system that provides a complex service by integrating a plurality of elementary services realized on computers, and realize a system that can easily adapt itself to expanding or changing the service.

To solve the above problems, the present invention has, in a service brokering apparatus for providing a complex service by integrating a plurality of elementary services realized on a computer, a mechanism for decomposing the complex service into the elementary services utilizing a combination of ID information on the elementary service entities, declarative descriptive information on the information needed to implement the elementary services, and the declarative descriptive information on the processing results of the elementary services so as to generate an elementary service request plan comprising strings of combinations of elementary service request information needed to implement the complex service, and ID information on the elementary service entities. This makes it possible to provide a method of easily using a complex service comprising a plurality of elementary services.

After this elementary service request plan has been produced, a request for an elementary service is actually made to an elementary service entity, and the processing results of the request are compiled to prepare the processing results of the complex service. This makes it possible to easily build a complex service using a plurality of elementary services.

A means for transmitting the elementary service request plan in accordance with requests from the outside after the request plan has been produced may be provided. This makes it possible for an external program to easily use a complex service comprising a plurality of elementary services.

The service brokering apparatus has also a mechanism for receiving a combination of ID information on the elementary service entities, declarative descriptive information on the information needed to implement the elementary services, and declarative descriptive information on the processing results of the elementary services from the outside, including the elementary service entities, and dynamically registering it in the inside. This makes it possible to dynamically reflect changes in the information describing the elementary services on the system.

The declarative descriptive information on the processing results of the elementary services and the declarative descriptive information on the information needed to implement the elementary services may be expressed using classes and objects of an object-oriented language, for example. This allows an existing language processing system to be used for building the system of the present invention.

Declarative descriptive information on the processing results of the elementary services and definition information (ontology) on vocabularies used in declarative descriptive information on the information needed to implement the elementary services can be managed independently of each other. This allows the descriptive information on the processing results of the elementary services and the definition information of vocabularies to be handled independently, leading to improved system legibility and expandability.

The elementary service request plan can be prepared by taking into account meta information describing the nature of the elementary service entities, in addition to the declarative descriptive information on the information needed to implement the services and the descriptive information on the processing results of the elementary services. This allows various types of information on the elementary services to be reflected in the preparation of the request plan.

Furthermore, the elementary service request plan can be prepared by taking into account information on the users' access rights to the elementary services, in addition to the declarative descriptive information on the information needed to implement the elementary services and the descriptive information on the processing results of the elementary services. This limits the availability of the elementary services only to the users having access rights, leading to improved system security. This also helps inhibit the generation of wasteful traffics or processing since no request is made for processing those elementary services to which the users have no access rights.

Moreover, the elementary service request plan can be prepared by taking into account information on the line speed and processing speed of the elementary services, in addition to the declarative descriptive information on the information needed to implement the services and the descriptive information on the processing results of the elementary services. This makes it possible to prepare the request plan by selecting the elementary services having high communication and processing efficiencies from among a plurality of elementary services of the same type available.

Moreover, the elementary service request plan can be prepared by taking into account information on the user preference to the elementary services, in addition to the declarative descriptive information on the information needed to implement the services and the descriptive information on the processing results of the elementary services. This makes it possible to prepare the request plan by selecting the elementary services having high user preference from among a plurality of elementary services of the same type available.

The above means can be realized with a software program that is executed by a computer provided in the service brokering apparatus. This software program can be stored in an appropriate recording medium that can be read by the computer, including a portable media memory, semiconductor memory, and hard-disk.

### BRIEF DESCRIPTION OF THE DRAWINGS

The objects, advantages and features of the present invention will be more clearly understood by reference to the following detailed disclosure and the accompanying drawings.

FIG. 1 shows a diagram illustrating an example of the overall system configuration of an embodiment of the present invention.

FIG. 2 shows a diagram illustrating an example of the overall configuration of a brokering agent (service brokering apparatus).

FIG. 3 shows a diagram illustrating an example of the structure of data to be stored in a service description storing section.

FIG. 4 shows a diagram illustrating an example of the structure of data to be stored in an ontology storing section.

FIG. 5 shows a processing flow chart of a brokering agent.

FIG. 6 shows a processing flow chart of a brokering agent.

FIG. 7 shows a processing flow chart of a brokering agent.

FIG. 8 shows a flow chart for building a service integration system to which the present invention was applied.

FIG. 9 shows a flow chart of an example of a brokering agent.

FIG. 10 shows a flow chart of an example of a brokering agent.

FIG. 11 shows a flow chart of an example of a brokering agent.

### DESCRIPTION OF THE PREFERRED EMBODIMENTS

An ex ample where ordinary elementary services on a computer are integrated using an interactive agent system will be described in the following as an embodiment of the present invention. The term service used here is not limited to the function as a mere information source, but is supposed to mean, in a general sense, whatever provides any types of computer processing to users. It is also supposed that such processing results are returned to users as a declarative description.

“Declarative description” states ‘what’ properties the object of description has. By contrast, the term “procedural description” states ‘how” prroperties the object of description is obtained. Declarative description is used mainly to describe facts and rules, whereas procedural description is used to describe procedures and functions.

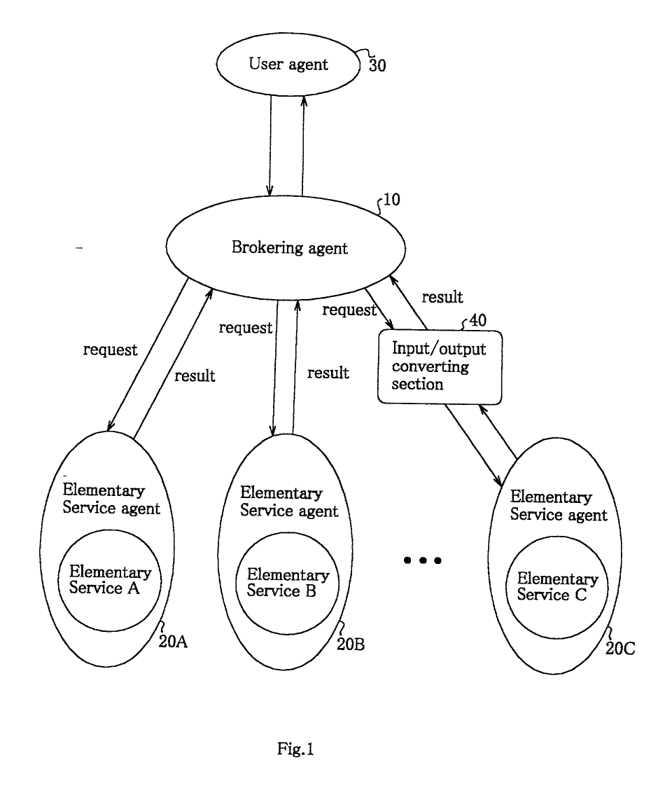

FIG. 1 shows the overall system configuration of an embodiment of the present invention. This system comprises a brokering agent 10, elementary service agents 20A, 20B, - - - , and a user agent 30, as shown in FIG. 1, and these agents are connected in such a manner that they can communicate with each other via a network (not shown).

These agents are realized by computers and software programs executed by the computers, while the elementary service agents 20A, 20B, - - - provide their own elementary services A, B, - - - . The user agent 30 is a processing unit enjoying a virtual complex service into which some of the elementary services A, B, - - - are integrated. Although only one user agent 30 is shown in FIG. 1, multiple user agents can be provided.

The brokering agent 10 lying between the user agent 30 and the elementary service agents 20A, 20B, - - - has such a function as to allow the user agent 30 to receive a complex service without being aware of the existence of the elementary service agents 20A, 20B, - - - .

The elementary service A is a flight reservation service, the elementary service B a hotel reservation service, - - - , and the elementary service C a rent-a-car reservation service, for example, and the elementary service agents 20A, 20B, - - - may be whatever existing elementary service providing systems adapted for use as agents. The brokering agent 10 provides to the user agent 30 a complex service combining these elementary services, and, upon request of the user agent 30 for a complex service, generates a request plan for requesting processing to each of the elementary service agents 20A, 20B, - - - , using service description information comprising a combination of identification information for identifying elementary service entities, declarative description information on the information needed to implement the elementary services, and declarative description information on the processing results of the elementary service, all stored in the service description storing section 17, so as to enable the user agent 30 to enjoy the complex service, as will be described later.

Where an elementary service agent has no uniform input/output interface with the brokering agent 10, as in the case of the elementary service agent 20C, an input/output data conversion section 40 is provided between the elementary service agent and the brokering agent 10 so that input/output data are converted into a prescribed format to allow the use of uniform input/output interface.

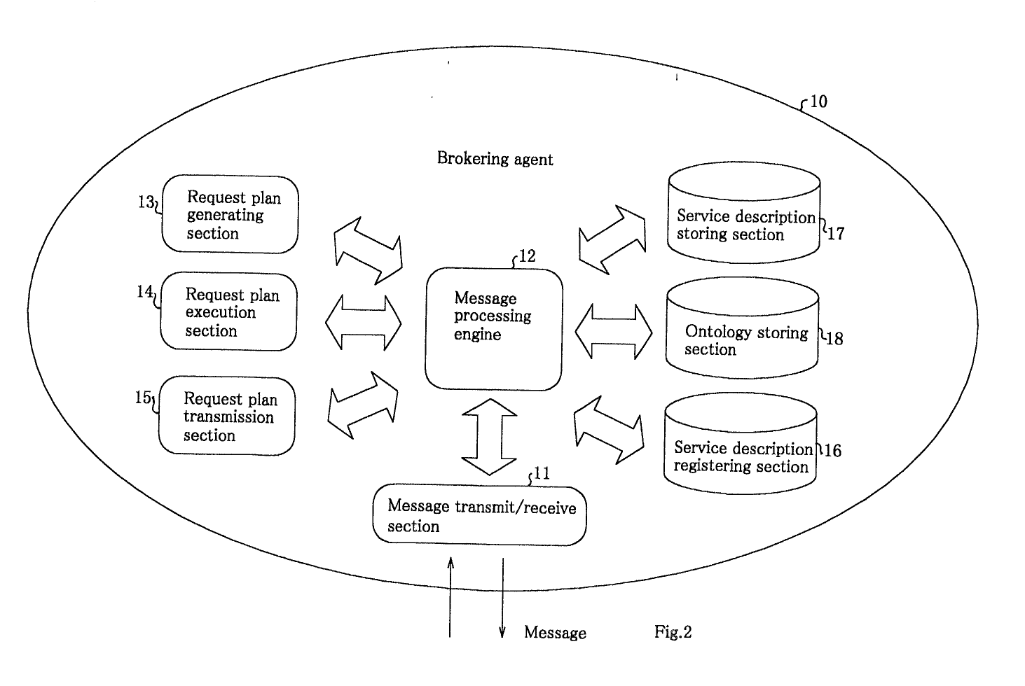

FIG. 2 shows an example of the configuration of the brokering agent (service brokering apparatus) 10. The brokering agent 10 comprises a message transmit-receive section 11, a message processing engine 12, a request plan generating section 13, a request plan execution section 14, a request plan transmission section 15, a service description registering section 16, a service description storing section 17 and an ontology storing section 18.

The message transmit/receive section 11 transmits and receives messages with external agents. The message processing engine 12 processes the received messages in accordance with the types of messages.

The request plan generating section 13, in response to a request message for a complex service, decomposes the complex service into the elementary services, and generates an elementary service request plan comprising at least strings of combinations of the elementary service request information needed to implement the complex service, and the identification information for identifying the elementary service entities. The request plan generating section 13 also generates an elementary service request plan taking into account meta information describing the nature of the elementary service entities themselves, in addition to the declarative description information on the information needed to implement the elementary services and the declarative description information on the processing results of the elementary services. As the meta information, information on user's access rights to the elementary services, information on the line speed or processing speed of the elementary services and information on the user preference of the elementary services, for example, may be used.

Based on the elementary service request plan produced by the request plan generating section 13, the request plan execution section 14 actually makes a request for elementary services to the elementary service agents 20A, 20B, - - - which are elementary service entities, compiles the processing results to prepare the processing results of the complex service, and informs the requesting user agent 30 of the results via the message transmit/receive section 11. The request plan transmission section 15 returns the plan information on the elementary service request plan generated by the request plan generating section 13 to the requesting user agent 30, rather than executing the plan. The service description registering section 16, upon receipt of a service description registration request message from an external agent, checks the message for the agent's qualification and the contents of the request message as necessary, and then registers and stores it in the service description storing section 17.

The service description storing section 17 is a means for storing service description information comprising a combination of identification information of elementary service entities, declarative description information on the information needed to implement the elementary services, and declarative description information on the processing results of the elementary services, for elementary services provided by the elementary service agents 20A, 20B, - - - . The identification information of elementary service entities refers to ID information or agent name given uniquely to each of the elementary service agents 20A, 20B, - - - .

The ontology storing section 18 is a means for storing definition information (that is called ontology) of vocabularies used in the declarative description information on the information needed to implement the elementary services and the declarative description information on the processing results of the elementary services.

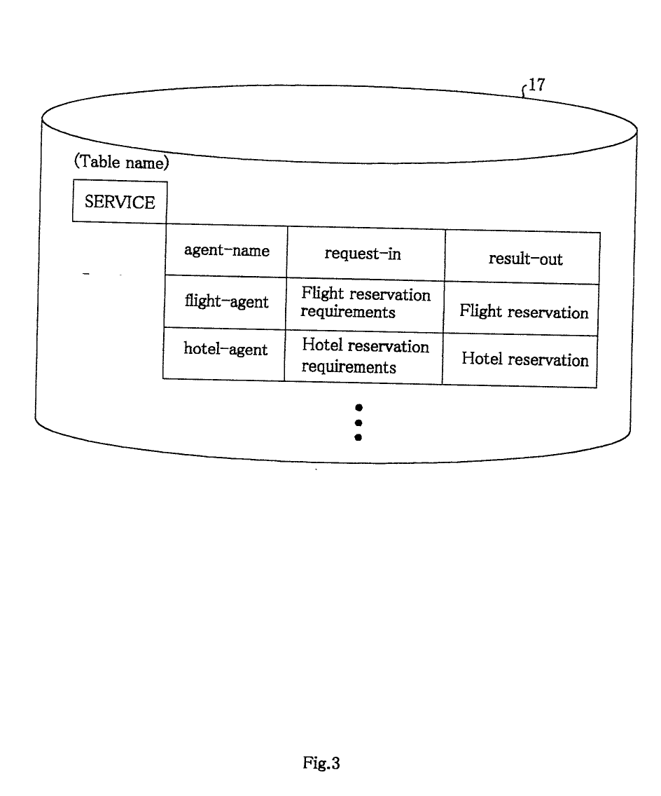

FIG. 3 shows an example of the construction of the data stored in the service description storing section 17. This example represents a case where the service description is stored in a table format, with the table name of “SERVICE.” In the table shown in FIG. 3, the names (identification information) of the elementary service agents are stored in the “agent-name” field, the declarative description information on the information needed to implement the elementary services is stored in the “request-in” field, and the declarative description information on the processing results of the elementary services is stored in the “result-out” field.

The service description storing section 17 can express the declarative description information on the information needed to implement the elementary services and the declarative description information on the processing results of the elementary service, for example, in classes or objects of an object-oriented language, rather than storing these pieces of information in the table format.

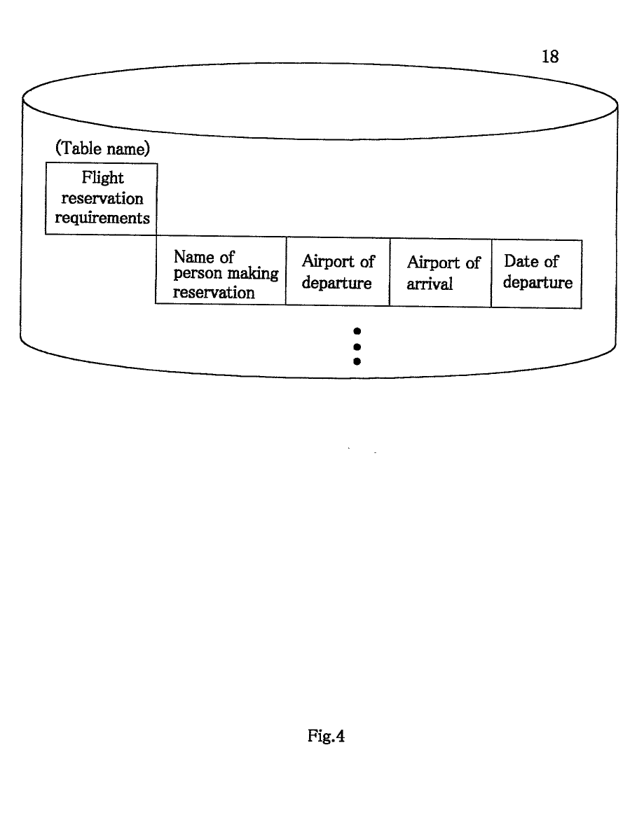

FIG. 4 shows an example of the construction of the data stored in the ontology storing section 18. The ontology also has a tabled data structure, and for each of the declarative description information on the information needed to implement the elementary services and the declarative description information on the processing results of the elementary services, definition information of vocabularies used for them is given as the field name of the table. That is, the ontology is expressed as a table that has only a field name and does not have any field value.

Although the service description storing section 17 and the ontology storing section 18 in FIG. 2 are expressed as databases inside the brokering agent 10, they may be realized in the form of agents existing outside the brokering agent 10 as independent elementary services that provide information.

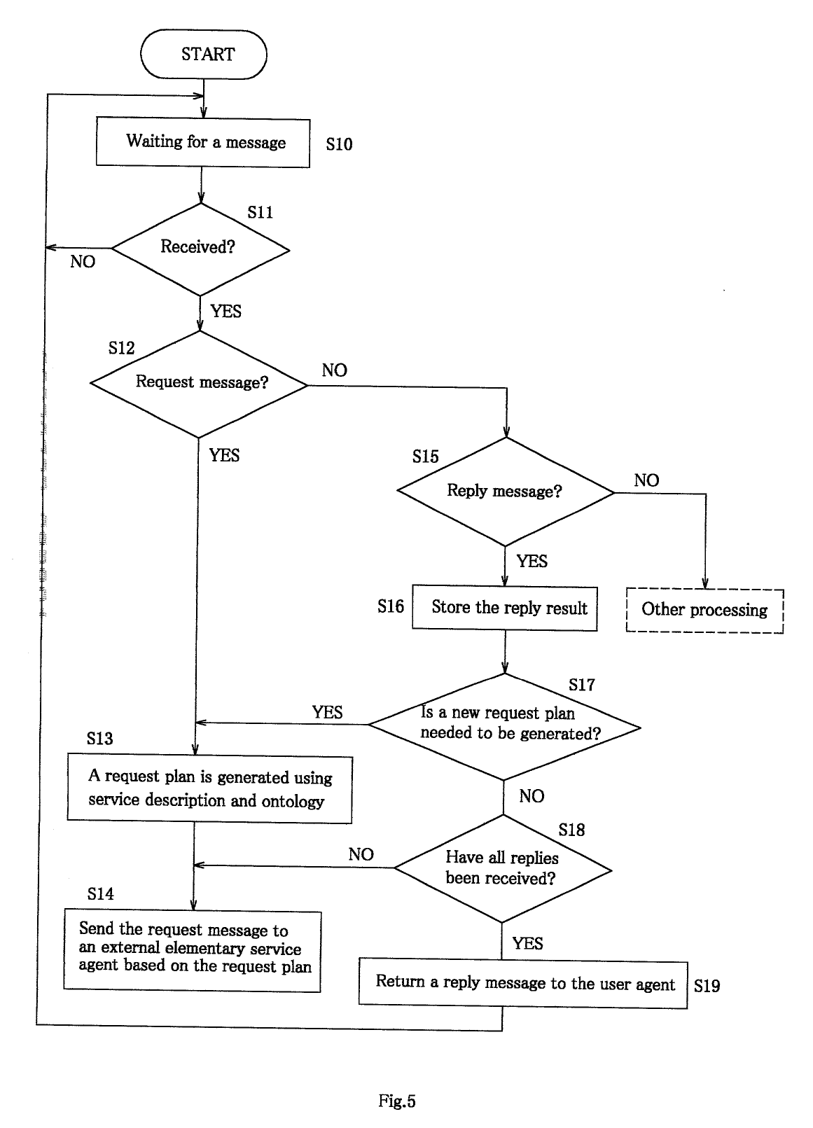

FIG. 5 is a processing flow chart of the brokering agent 10. The example shown in FIG. 5 is a case where the brokering agent 10 prepares a request plan, executes it, and returns only the final processing results to the user agent 30.

The brokering agent 10 waits for request messages (request) from user agents 30, and reply messages (result) from each of the elementary service agents 20A, 20B, - - - (Steps S10 and S11). Upon receipt of a message, the brokering agent 10 judges whether or not the received message is a request message (Step S12). If it is not a request message, the brokering agent 10 proceeds to Step S15.

If the received message is a request message requesting a complex service from a user agent 30, the brokering agent 10 activates the request plan generating section 13 to decompose the complex service into elementary services using the service description held by the service description storing section 17 and the ontology held by the ontology storing section 18, and generates a request plan to the elementary service agents 20A, 20B, - - - (Step S13).

The request plan execution section 14 transmits request messages to the relevant elementary service agents 20A, 20B, - - - based on the request plan generated by the request plan generating section 13 (Step S14) and waits for responses.

When the received message is a replay messages from any of the elementary service agents 20A, 20B, - - - (Step S15), the brokering agent 10 proceeds to Step S16. If the received message is neither a request message nor a replay message, the brokering agent 10 performs processing suited to the type of the message.

When a reply message is received from any of the elementary service agents 20A, 20B, - - - , the brokering agent 10 stores the reply result (Step S16) and judges whether generation of a new request plan is needed in accordance with the reply message (Step S17). If generation of a new request plan is needed, the brokering agent 10 proceeds to Step S13 to generate a new request plan (including a change in the previously generated request plan). If generation of a new request plan is not necessary, then the brokering agent 10 judges whether reply messages have been received to all the request messages based on the request plan (Step S18). If all the replay messages have been received, the brokering agent 10 prepares a reply message to the user agent 30 by compiling the processing results from each of the elementary service agents 20A, 20B, - - - , and returns it to the user agent 30 (Step S19). If all the reply messages have not yet been received, the brokering agent 10 returns to Step S10 to wait for the receipt of reply messages to the request for the elementary services, or goes to Step S14 to send the next request message that has not yet been requested in the request plan to the relevant elementary service agents 20A, 20B, - - - . The above processing is repeated for each message.

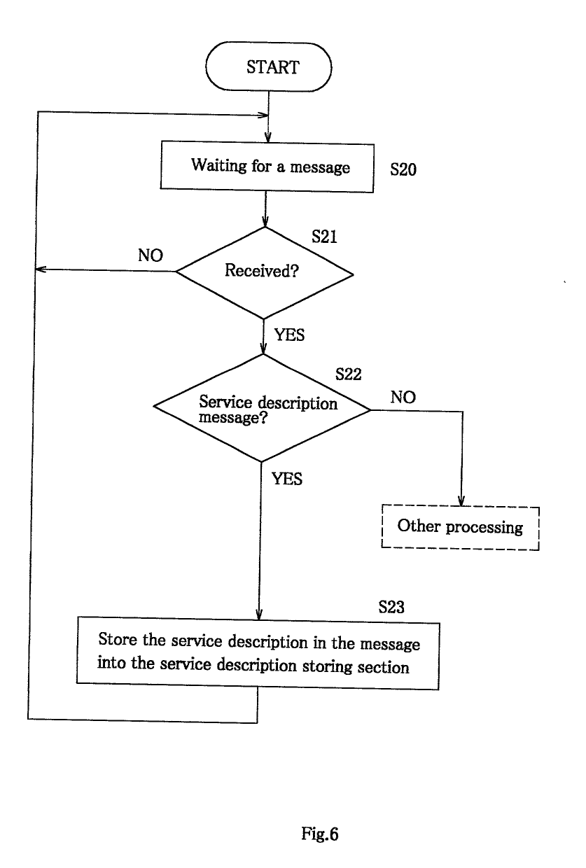

FIG. 6 is a processing flow chart of the brokering agent 10 illustrating an example of processing of a service description message from the elementary service agents 20A, 20B, - - - . Steps S20 and S21 in FIG. 6 are the same processing as in Steps S10 and S11 in FIG. 5.

The brokering agent 10 waits for messages from other agents (Step S20). Upon receipt of a message, the brokering agent 10 judges whether that message is a service description message (Step S22). If it is a service description message from any of the elementary service agents 20A, 20B, - - - or other agents, the brokering agent 10 calls the service description registering section 16 to check the message for its qualification and contents for service description registration as necessary, and then stores the service description in that message in the service description storing section 18. After that, the brokering agent 10 returns to Step S20 to wait for the next message.

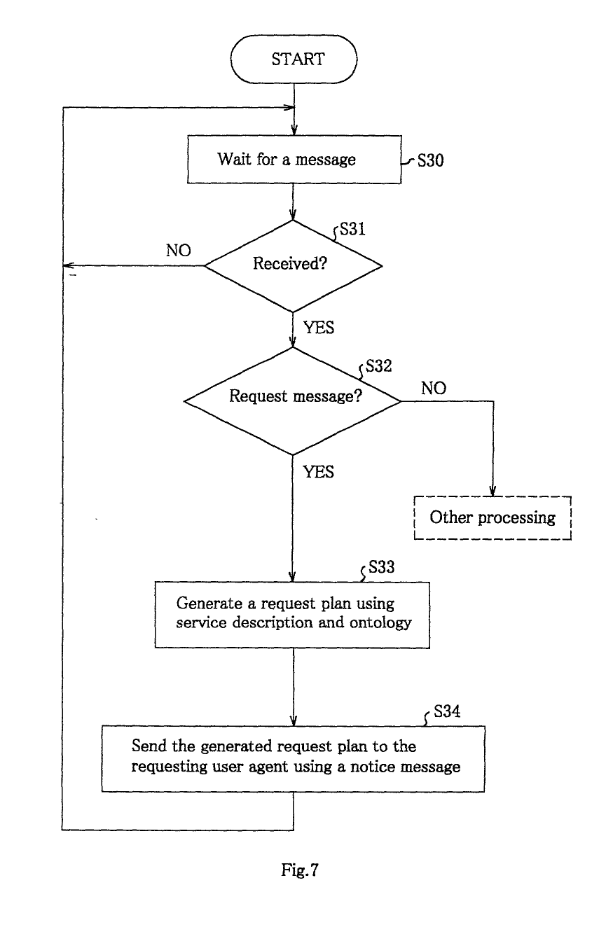

FIG. 7 is a processing flow chart of the brokering agent 10 where a request plan addressed to the elementary service agents 20A, 20B, - - - is generated in response to a request message from a user agent 30, and the request plan is returned to the user agent 30. The request plan is executed by the user agent 30 who received the request plan.

The brokering agent 10 waits for a request message (request) from a user agent (Steps S30 and S31). Upon receipt of a message, the brokering agent 10 judges whether that message is a request message from the user agent 30 for generating a request plan for a complex service (Step S32), and if it is not a request message, performs other processing suited to the type of the message.

If the received message is a request message from the user agent 30, the brokering agent 10 activates the request plan generating section 13 to decompose the complex service into elementary services using the service description held by the service description storing section 17 and the ontology held by the ontology storing section 18, and generates a request plan to the elementary service agents 20A, 20B, - - - (Step S33). The request plan transmission section 15 sends the request plan generated by the request plan generating section 13 to the requesting user agent 30 using a notification message (Step S34). After that, the brokering agent 10 returns to Step S30 to wait for the receipt of the next message.

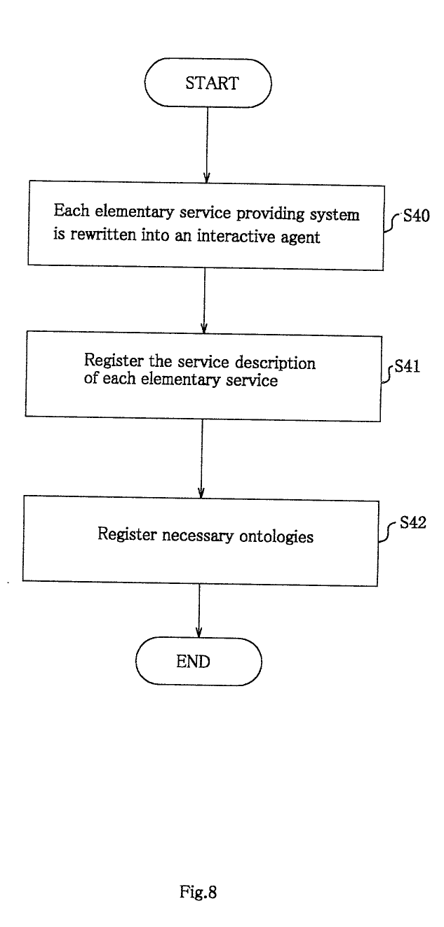

FIG. 8 is a flow chart of building a service integration system to which the present invention is applied. Where there are a plurality of elementary service providing systems, each of the elementary service providing systems are first adapted into interactive agents to build a service integration system for providing a complex service combining the elementary service providing systems (Step S40). At this time, an input/output data conversion section 40 as shown in FIG. 1 is added as necessary. Next, the service description of each elementary service is registered in the service description storing section 17 (Step S41), and a necessary ontology is registered in the ontology storing section 18 (Step 42).

Next, the method for building a service integration system and the method for generating a request plan will be described in accordance with operative examples. The following operative example is a case where a new travel reservation service is built using a flight reservation service and a hotel reservation service, which are separately provided.

Now, suppose that there is a flight reservation system for users, for example,, which can secure an adequate flight reservation upon entry of necessary information, including the name of a person who makes a reservation, airport of departure, airport of arrival, departure time and arrival time. Individual elementary services constituting a complex service, such as this flight reservation service, are called elementary services. This flight reservation service returns to the user information on a flight reservation ID, flight name, airport of departure, airport of arrival, departure time, and arrival time as the result of reservation processing. This situation can be expressed by the following description using a frame-type data structure. Frame used here is a data structure having a syntax such as

$$\text{(<<frame name>>} \\ \text{(<slot name> <slot value>)} \\ \text{(<slot name> <slot value>)} \\ … \text{)} \qquad \text{(Equation 1)}$$

In the current case, the flight reservation can be regarded as a system which receives a frame (slot values omitted) where an input from a user is expressed as

$$\text{(<<flight reservation requirements>>} \\ \text{(name of person making a reservation-----)} \\ \text{(airport of departure-----)} \\ \text{(airport of arrival-----)} \\ \text{(departure date-----))} \qquad \text{(Equation 2)}$$

, actually makes a flight reservation, and returns a frame (slot values omitted) where the following reservation processing results are expressed.

$$\text{(<<flight reservation>>} \\ \text{(flight reservation ID)} \\ \text{(flight name)} \\ \text{(airport of departure)} \\ \text{(airport of arrival)} \\ \text{(departure time)} \\ \text{(arrival time))} \qquad \text{(Equation 3)}$$

In order to adapt the flight reservation system into an interactive agent (agent name: flight-agent) using a standard method, the system is wrapped with adequate codes to furnish the system with a function to communicate with the outside, and enable exchanges of messages, including the abovementioned frames. The term “to wrap a system with adequate codes” specifically means adding to the input/output portion of the existing system a program for converting the existing input/output data format of an existing flight reservation system, which has no frame-type input/output interface, into a frame-type input/output data format. The input/output data conversion section 40 shown in FIG. 1 corresponds to this program.

Now, a message such as

$$\text{(request} \\ \text{:content} \\ \text{(<<flight reservation requirements>>} \\ \text{(name of person making a reservation} \\ \text{"John Doe")} \\ \text{(airport of departure "Narita")} \\ \text{(airport of arrival "Heathrow")} \\ \text{(departure date "2000/01/01)} \\ \text{:sender user-agent} \\ \text{:receiver flight-agent)} \qquad \text{(Equation 4)}$$

is defined as a message requesting reservation from a user.

The beginning of a message indicates the type of the message; “request” in this example indicates a request for processing with the content tagged with “:content” as requirements. “:sender” and “:receiver” are tags attached to the names of an agent who sends this message and an agent who receives it. “user-agent” is the name of an agent (user agent 30 in FIG. 1) who sends and receives such a message on behalf of a user. Actual communications are normally carried out by a communication environment provided externally for the agent systems.

Upon receipt of such a request message, “flight-agent” actually carries out a flight reservation in accordance with flight reservation requirements, and in the event of success in the reservation, returns the following reply message:

$$\text{(result} \\ \text{:content} \\ \text{(<<flight reservation>>} \\ \text{(flight reservation ID "\#00195")} \\ \text{(flight name "JL333")} \\ \text{(airport of departure "Narita)} \\ \text{(airport of arrival "Heathrow")} \\ \text{(departure time "2000/01/01 18:00")} \\ \text{(arrival time "2000/01/02 10:00))} \\ \text{:sender flight-agent} \\ \text{:receiver user-agent} \qquad \text{(Equation 5)}$$

With this, an existing flight reservation service has become available as one of interactive agent. In this flight reservation service, there is only one reply frame, but in general there can be a service that can reply with a plurality of frames.

There also exists an elementary service for making hotel reservations, independently of the aforementioned flight reservation service, where by giving the name of a person making a reservation, the length of stay, and the name of city of stay, a reservation of an adequate hotel is made, and information on the hotel reservation ID, the name of hotel and the length of stay will be returned to the person making that reservation.

In this condition, the service can also be adapted into an interactive agent (agent name: hotel-agent) by defining each frame as follows:

$$\begin{matrix}\text{(<<hotel reservation requirements>>} \\ \text{(name of person making a reservation)} \\ \text{(length of stay)} \\ \text{(name of city of stay))} & \text{(Equation 6)} \\ \text{(<<hotel reservation>>} \\ \text{(hotel reservation ID)} \\ \text{(name of hotel)} \\ \text{(length of stay))} & \text{(Equation 7)}\end{matrix}$$

And then, an agent is prepared which can, in response to the following hotel reservation request message,

$$\text{(request} \\ \text{:content} \\ \text{(<<hotel reservation requirements>>} \\ \text{(name of person making a reservation} \\ \text{"John Doe)} \\ \text{(day of stay "2000/01/02")} \\ \text{(name of city of stay "London")} \\ \text{:sender user-agent} \\ \text{:receiver hotel-agent)} \qquad \text{(Equation 8)}$$

return a hotel reservation reply message such as

$$\text{(result} \\ \text{:content} \\ \text{(<<hotel reservation>>} \\ \text{(hotel reservation ID "\#255")} \\ \text{(name of hotel "Savoy")} \\ \text{(day of stay "2000/01/02"))} \\ \text{:sender hotel-agent} \\ \text{:receiver user-agent)} \qquad \text{(Equation 9)}$$

Next, suppose to built a new travel reservation service by integrating flight and hotel reservations by using these agents. Although a travel reservation-specific service or a dedicated agent can be established of course by having and using “flight-agent” and “hotel-agent” under it, when considering system expandability and versatility, it is more desirable to build a brokering agent that can virtually implement a higher-order service by brokering and integrating elementary services/agents. This is the brokering agent 10 shown in FIG. 1.

If an arrangement is made to register frame pairs expressing the requirements and results of services offered by elementary service agents in the brokering agent 10, various brokering services can be implemented using this information. More specifically, the following description is registered by using frames to describe the “flight-agent” service.

$$\text{(<<SERVICE>>} \\ \text{(agent-name flight-agent)} \\ \text{(request-in} \\ \text{(<<flight reservation requirements>>))} \\ \text{(result-out} \\ \text{(<<flight reservation>>)))} \qquad \text{(Equation 10)}$$

This indicates that when “flight-agent” receives a reservation request message having the <<flight reservation requirements>> frame, and the reservation has been successfully made, it has a capability of returning a <<flight reservation>> frame as the result. A similar description of a service offered by “hotel-agent” is as follows:

$$\text{(<<SERVICE>>} \\ \text{(agent-name hotel-agent)} \\ \text{(request-in} \\ \text{(<<hotel reservation requirements>>))} \\ \text{(result-out} \\ \text{(<<hotel reservations>>)))} \qquad \text{(Equation 11)}$$

The brokering agent 10 (agent name: facilitator) is an agent that can offer a travel reservation service combining flight and hotel reservation services. A travel reservation service can be described in terms of frames as follows:

$$\text{(⪡travel reservation⪢} \text{(⪡flight reservation⪢)} \\ \text{(⪡hotel reservation⪢))} \qquad ( Equation 12 )$$

When a user asks the brokering agent 10 to make a travel reservation via a user agent 30, the user notice the brokering agent 10 of user information by filling the following frames with slot values. The brokering agent 10 stores this.

$$\text{(⪡travel reservation requirements⪢} \\ \text{(name of person making a reservation)} \\ \text{(airport of departure)} \\ \text{(airport of arrival)} \\ \text{(date of departure)} \\ \text{(date of stay)} \\ \text{(name of city of stay)} \qquad ( Equation 13 )$$

At this point of time, the brokering agent 10 has service description frames of (Equation 10) and (Equation 11), the definition of a <<travel reservation>> frame of (Equation 12), and frame knowledge prepared by filling a <<travel reservation requirements>> frame of (Equation 13) with slot values. Under these conditions, the brokering agent 10 has become able to provide a travel reservation service (that is, a service returning a <<travel reservation>> frame to the user agent 30). More specifically, this process proceeds with the following flow.

The user agent 30 asks the travel reservation service for a <<travel reservation>> frame by sending to the brokering agent 10 a request message, including a <<travel reservation requirements>> frame.

When asked for a <<travel reservation>> frame, the brokering agent 10 judges from (Equation 12) that a <<travel reservation>> frame can be prepared if there are <<flight reservation>> and <<hotel reservation>> frames.

The brokering agent 10 judges from (Equation 10) that a <<flight reservation>> can be obtained by sending a request message, including data on <<flight reservation requirements>> to the flight agent.

The brokering agent 10 judges from (Equation 11) that a <<hotel reservation>> can be obtained by sending to the hotel-agent a request message, including data on <<hotel reservation requirements>>.

The brokering agent 10 judges from its <<travel reservation requirements>> frame that frame knowledge on <<flight reservation requirements>> and <<hotel reservation requirements>> can be prepared, and makes up the following request plan:

$$\text{(⪡request plan⪢} \\ \text{(⪡elementary service request⪢} \\ \text{(agent-name flight-agent)} \\ \text{(request-message “(request:content (⪡flight reservation} \text{requirements⪢ … )”))} \\ \text{(⪡elementary service request⪢} \\ \text{(agent-name hotel-agent)} \\ \text{(request-message “(request:content(⪡hotel reservation} \\ \text{requirements⪢ … )”))} \qquad ( Equation 14 )$$

The portions . . . in (Equation 14) contain values delivered from (Equation 4) and (Equation 8).

This plan comprises strings of elementary service requests where each elementary service request comprises a pair of the name of a requesting agent and a request message.

(6) The brokering agent 10 actually sends a message to each agent along with the prepared request plan, and extracts the frame knowledge of <<flight reservation>> and <<hotel reservation>> from the message returned as a reply, and assembles a <<travel reservation>> frame and returns it to the user.

In (5) above, the brokering agent 10 judges that frame on <<flight reservation requirements>> and <<hotel reservation requirements>> can be prepared from the <<travel reservation requirements>> frame. This can be realized by giving to the brokering agent 10 the following equal-sign relationship for all items, for example:

$$\text{(=(⪡} travel reservation requirements \text{⪢} \\ ( name of person making a reservation ) ) \\ \text{(⪡} flight reservation requirements \text{⪢} \\ ( name of person making a reservation ) ) ) \\ \text{(=(⪡} travel reservation requirements \text{⪢} \\ ( airport of departure ) ) \\ \text{(⪡} flight reservation requirements \text{⪢} \\ ( airport of departure ) ) ) \qquad ( Equation 15 )$$

The service description of the brokering agent 10 realized here can be written as follows:

$$\text{(⪡} SERVICE \text{⪢} \\ ( agent \text{-} name facilitator ) \\ ( request \text{-} in \\ \text{(⪡} travel reservation requirements \text{⪢} ) ) \\ ( result \text{-} out ) \\ \text{(⪡} travel reservation \text{⪢} ) ) ) \qquad ( Equation 16 )$$

If this information is transmitted and stored in the outside, the user agent 30 knows an agent to which the user agent 30 can ask for a travel reservation, or builds a system for automatically assemble a more sophisticated service using this brokering agent 10.

The brokering agent 10 as described above does not specialize in travel reservation, but can realize various service integration by registering declarative service descriptions, such as (Equation 10) and (Equation 11) for various services. That is, the service description (Equation 10) of “flight-agent” and the service description (Equation 11) of “hotel-agent” are registered in the service description storing section 17. In (Equation 10) and (Equation 11), one frame is given to each of “request-in” and “result-out,” but more complicated services can generally be described by giving a plurality of frames.

These service descriptions can be dynamically registered by sending messages from elementary service agents, aside from giving the service descriptions to the brokering agent 10 as set data.

(Equation 2), (Equation 3), (Equation 6), (Equation 7), (Equation 12), (Equation 13), and (Equation 15) are definitions of vocabularies used for the contents of messages exchanged between agents, which is called ontologies. Ontologies, which are independent from service descriptions such as (Equation 10) and (Equation 11), can be separately controlled en bloc. If the age of a user is added to <<flight reservation requirements>>, for example, the ontology has to be updated, but the service description of (Equation 10) need not be changed.

Although only one elementary service agent of the same type is given in the examples in this section, there can generally be provided a plurality of elementary service agents. In such a case, any type of service can be provided so long as the service description satisfies conditions. The scope of service can be further narrowed down by using meta-descriptions for elementary service agents, aside from service descriptions. Examples of such meta-descriptions include users' access rights, service processing speed, user preference, etc.

### Examples of the Invention

<<An Example of the Processing of a Travel Reservation Request>>

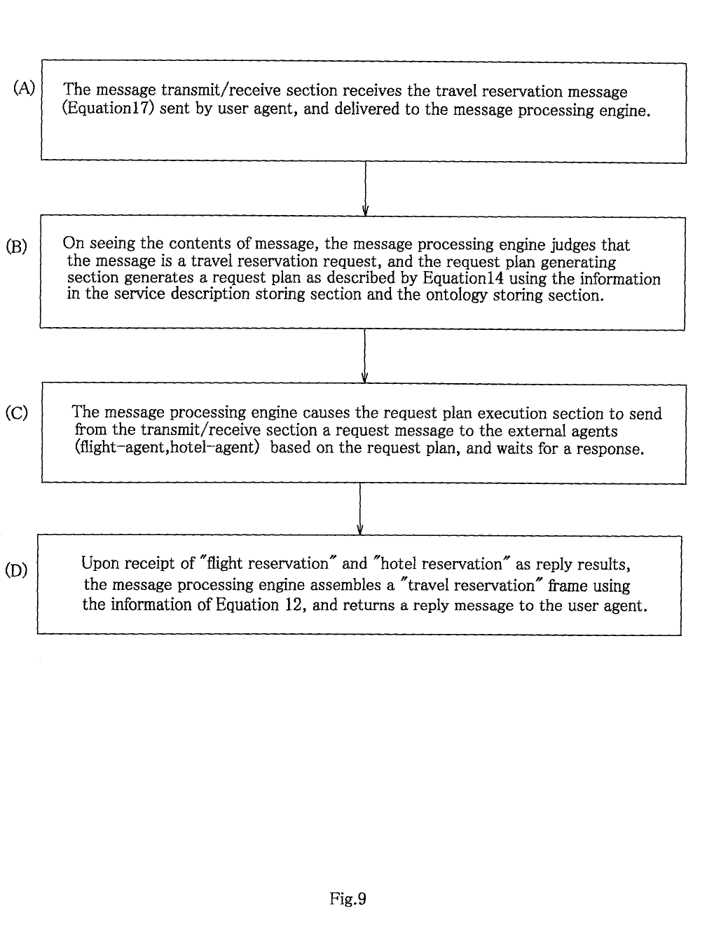

FIG. 9 is a flow chart of an example of the brokering agent 10 shown in FIG. 2. This flow chart shows an example in which the travel reservation system described in “Best Mode For Carrying Out The Invention” is realized. The processing flow is based on the assumption that the service description (Equation 10) of “flight-agent” and the service description of “hotel-agent” are stored in the service description storing section 17 in such a form as shown in FIG. 3.

It is also assumed that the definition (Equation 2) of “flight reservation requirements”, the definition (Equation 3) of “flight reservation,” the definition (Equation 6) of “hotel reservation requirements,” the definition (Equation 7) of “hotel reservation,” the definition (Equation 12) of “travel reservation,” the definition (Equation 13) of “travel reservation requirements” and the equal-sign relationship (Equation 15) are stored in the ontology storing section 18 in such a form as shown in FIG. 4.

The flow shown in FIG. 9 begins when the user agent 30 sends the following to the brokering agent 10 that is in such a state:

$$( request \\ \text{:} content \\ \text{(⪡} travel reservation requirements \text{⪢} \\ ( name of person making a reservation “ John Doe ” ) \\ ( airport of departure “ Narita ” ) \\ ( airport of arrival “ Heathrow ” ) ( date of departure “ 2000 \text{/} 01 \text{/} 01 ” ) \\ ( date of stay “ 2000 \text{/} 01 \text{/} 02 ” ) \\ ( name of city of stay “ London ” ) \\ \text{:} sender user \text{-} agent \\ \text{:} receiver facilitator \qquad ( Equation 17 )$$

In the following, the processing will be described according to (A)˜(D) shown in FIG. 9.

(A) A travel reservation message (Equation 17) sent from the user agent 30 is received by the message transmit/receive section 11, and delivered to the message processing engine 12.

(B) On seeing the contents of the received message, the message processing engine 12 judges that it is a request for travel reservation, and calls the request plan generating section 13, which in turn generates a request plan as shown in (Equation 14) using the information stored in the service description storing section 17 and the ontology storing section 18.

(C) Next, the message processing engine 12 causes the request plan execution section 14 to send a request message to the flight reservation agent (flight-agent) and the hotel reservation agent (hotel-agent), both of which are located outside, via the message transmit/receive section 11 in accordance with a request plan prepared by the request plan generating section 13, and waits for a response.

(D) Upon receipt of “flight reservation” and “hotel reservation” as the response, the message processing engine 12 prepares a “travel reservation” frame using the information of (Equation 12), and returns a reply message (result) to the user agent 30.

<<An Example of Dynamic Registration of Service Description>>

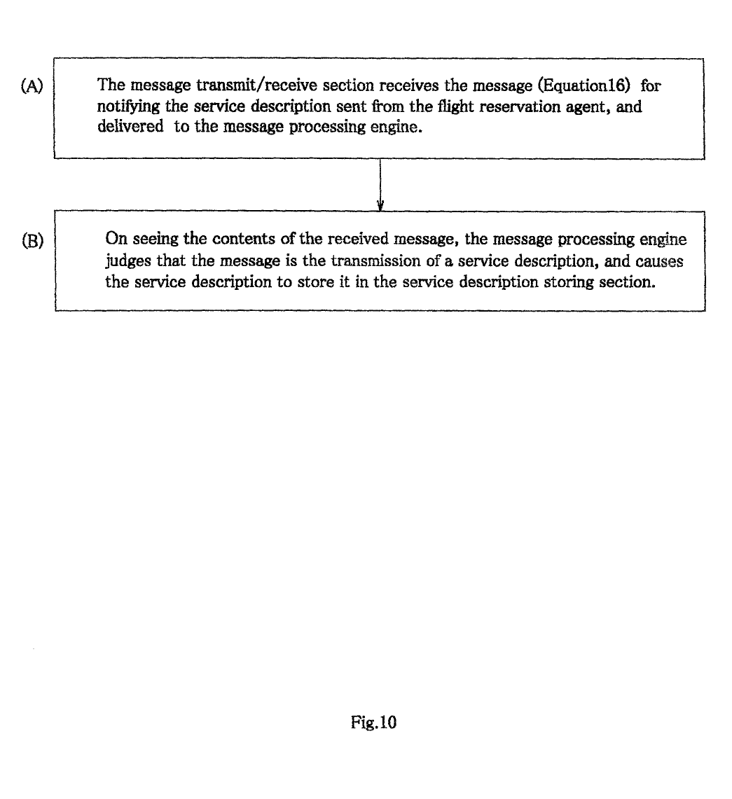

FIG. 10 is a flow chart of an example of the brokering agent 10 shown in FIG. 2 where a service description is dynamically registered and stored in the service description storing section 17 at the request of an elementary service agent.

Now suppose that the service description (Equation 10) on the flight reservation agent (flight-agent) as an elementary service agent is not held by the brokering agent 10, and the flight reservation agent (flight-agent) transmits the service description on its own in (Equation 10) to the brokering agent 10. A notification message (tell) for an agent to tell the fact to the other agents is defined as a message for that purpose. More specifically, the flight reservation agent (flight-agent) sends the following to the brokering agent 10 (facilitator).

$$( tell \\ \text{:} content \\ \text{(⪡} SERVICE \text{⪢} \\ ( agent \text{-} name flight \text{-} agent ) \\ ( request \text{-} in \\ \text{(⪡} flight reservation requirements \text{⪢} ) ) \\ ( result \text{-} out \\ \text{(⪡} flight reservation \text{⪢} ) ) ) \\ \text{:} sender flight \text{-} agent \\ \text{:} receiver facilitator ) \qquad ( Equation 18 )$$

The flow chart of the processing by the brokering agent 10 upon receiving it is as shown in FIG. 10.

(A) The message transmit/receive section 11 receives a message (Equation 18) notifying the service description sent by the flight reservation agent (flight-agent), and delivered to the message processing engine 12.

(B) On seeing the contents of the received message, the message processing engine 12 judges that it is the service description, and causes the service description registering section 16 to store it in the service description storing section 17.

<<An Example of the Use of Object-Oriented Language>>

In service descriptions, declarative description information on the information needed to realize a n elementary service and declarative description information on the processing results of the elementary service can be expressed by classes or objects of an object-oriented language. In the following, shown is an example where “flight reservation requirements” and “flight reservation” of (Equation 10) are expressed by classes of Java language.

$$public class flight reservation requirements$$

$$\{ public String name of person making a reservation , \\ airport of departure , airport of arrival , date of departure ; \}$$

$$public class flight reservation$$

$$\{ public String flight reservation ID , f light name , airport of \\ departure , airport of arrival , departure time , arrival time \}$$

<<An Example of the Use of Meta-Information>>

The request plan generating section 13 in FIG. 2 can prepare an elementary service request plan taking into account meta-information describing the nature of the elementary service itself, in addition to declarative description information on the information needed to realize an elementary service and declarative description information on the processing results of the elementary service in the service descriptions. Information on the access rights of users to elementary services, information on the line speed or processing speed of elementary services, and information on the user preference of elementary services, for example, can be used as such meta-information.

<An Example of Users' Access Rights>

When information having such a form as described in (Equation 19) below is made available in the brokering agent 10 as information expressing the availability to a user of an access right to the flight reservation agent (flight-agent), only those users who are judged as having access rights to the flight reservation agent based on this information among users who make requests for travel reservations to the brokering agent 10 are eligible for receiving a service request plan prepared by the brokering agent 10.

$$\text{(⪡} access right \text{⪢} \\ ( user name “ John Doe ” ) \\ ( agent name “ flight \text{-} agent ” ) ) \qquad ( Equation 19 )$$

<An Example of Line Speed>

Assume that information having such a form as described by (Equation 20) in the following, which expresses the line speed of a network used by each elementary service agent, is made available in the brokering agent 10, for example. In such a case, the brokering agent 10 attempts to make up a service request plan giving priority to an elementary service agent having a higher line speed.

$$\text{(⪡} line speed \text{⪢} \\ ( agent name “ flight \text{-} agent1 ” ) \\ ( bandwidth “ 64 kb ” ) ) \\ \text{(⪡} line speed \text{⪢} \\ ( agent name “ flight \text{-} agent2 ” ) \\ ( bandwidth “ 128 kb ” ) ) \qquad ( Equation 20 )$$

<An Example of User Preference>

Assume that information having such a form as described by (Equation 21), which expresses quantifying the degree of preference by individual users or user groups for elementary services, is made available in the brokering agent 10, for example. In such a case, the brokering agent 10 attempts to make up a service request plant giving priority to an elementary service agent having higher preference.

$$( \text{<<} preference \text{>>} \\ ( agent name '' flight \text{-} agent 1 '' \\ ( rating 5 ) ) \\ ( \text{<<} preference \text{>>} \\ ( agent name '' flight \text{-} agent 2 '' ) \\ ( rating 10 ) ) \qquad ( Equation 21 )$$

<<An Example of the Processing of a Request for Travel Reservation Request Plan>>

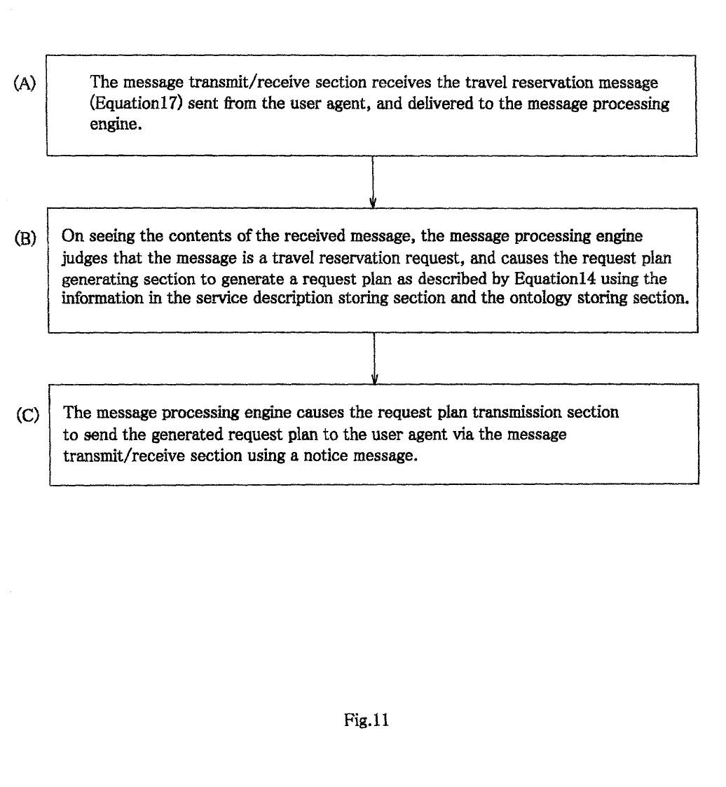

FIG. 11 is a flow chart of an embodiment of the brokering agent 10 shown in FIG. 2 where no service request is actually made to individual elementary service agents, but only a service request plan is returned to a user agent 30. In this case, it is assumed that an actual service request using this request plan is made by the user agent 30.

In this case, too, description will be made according to the example of travel reservation system described in “Best Mode For Carrying Out The Invention.” The flow chart of FIG. 11 is much like the flow chart of FIG. 9, except that service requests to individual elementary service agents are made on the side of the user agent 30.

(A) A travel reservation message (Equation 17) sent from a user agent 30 is received by the message transmit/receive section 11 and delivered to the message processing engine 12.

(B) On seeing the contents of the received message, the message processing engine 12 judges that it is a travel reservation request, calls the request plan generating section 13, which in turn generates a request plan as described by (Equation 14) using the information stored in the service description storing section 17 and the ontology storing section 18.

(C) The message processing engine 12 causes the request plan transmit section 15 to send the generated request plan from the message transmit/receive section 11 to the user agent 30 using a notification message (tell). This notification message (tell) is as shown below, and the content portion thereof is (Equation 14).

$$( tell \\ : content \\ ( \text{<<} request plan \text{>>} \\ ( \text{<<} elementary request \text{>>} \\ ( agent \text{-} name flight \text{-} agent ) \\ ( request \text{-} message '' ( request : content ( \text{<<} flight \\ reservation \\ requirements \text{>>} ) … ) '' ) ) \\ ( \text{<<} elementary request \text{>>} \\ agent \text{-} name hotel \text{-} agent \\ ( request \text{-} message '' ( request : content ( \text{<<} hotel \\ reservation \\ requirements >> ) … ) '' ) ) ) \\ : sender facilitator \\ : receiver user \text{-} agent ) \qquad ( Equation 22 )$$

As described above, the present invention can realize a system which virtually integrate a plurality of elementary services on computers using declarative descriptions on the elementary services to easily provide a complex service integrating a plurality of elementary services.

The many features and advantages of the invention are apparent from the detailed specification and, thus, it is intended by the appended claims cover all such features and advantages of the invention which fall within the true spirit and scope of the invention. Further, since numerous modifications and changes will readily occur to those skilled in the art, it is not desired to limit the invention to the exact construction and operation illustrated and described, and accordingly all suitable modifications and equivalent may be resorted to, falling within the scope of the invention.

What is claimed is:

1. A service brokering apparatus for providing a complex service integrating a plurality of elementary services realized on computers comprising:
means for storing service description information for each elementary service, the service description information comprising a combination of identification information of elementary service entities, declarative description information on information needed to realize the elementary services, and declarative description information on processing results of the elementary services;
means for transmitting and receiving messages; and
means for decomposing the complex service into the elementary services using the service description information upon receipt of a request message for the complex service from the outside, and generating an elementary service request plan comprising strings of combinations of at least elementary service request information needed to realize the complex service, and identification information of elementary service entities.

2. A service brokering apparatus as set forth in claim 1, comprising means for generating the elementary service request plan, then actually requesting an elementary service to an elementary service entity, and compiling the processing results so that the processing results of the complex service are prepared and notified to the requesting outside entity.

3. A service brokering apparatus as set forth in claim 1, comprising means for generating the elementary service request plan, then transmitting the request plan in response to a request for it from the outside.

4. A service brokering apparatus as set forth in claim 1, comprising means for receiving from the outside service description information comprising a combination of identification information of the elementary service entities, declarative description information on information needed to realize the elementary service thereof, and declarative description information on the processing results of the elementary service, and storing the service description information into means for dynamically registering the service description information.

5. A service brokering apparatus as set forth in claim 1, wherein the declarative description information on information needed to realize the elementary service and the declarative description information on the processing results of the elementary service are expressed by classes or objects of an object-oriented language.

6. A service brokering apparatus as set forth in claim 1, comprising ontology storing means for storing definition information on vocabularies used in the declarative description information on information needed to realize the elementary service and the declarative description information on the processing results of the elementary service.

7. A service brokering apparatus as set forth in claim 1, wherein the means for generating the elementary service request plan prepares the elementary service request plan taking into account meta-information describing the nature of the elementary service entity itself, in addition to the declarative description information on information needed to realize the elementary service and the declarative description information on the processing results of the elementary information.

8. A service brokering apparatus as set forth in claim 7, wherein the meta-information used for preparing the elementary service request plan is information on users' access rights to elementary services, information on the line speed or processing speed of elementary services, or information on the user preference of the elementary services.

9. A service brokering method for providing a complex service integrating a plurality of elementary services realized on computers comprising:
storing for each elementary service, service description information comprising a combination of identification information of elementary service entities, declarative description information on information needed to realize the elementary services, and declarative description information on the processing results of the elementary services; and,
upon receipt of a request message for the complex service from the outside, decomposing the complex service into the elementary services using the service description information, and generating a service request plan comprising strings of combinations of at least elementary service request information needed to realize the complex service, and identification information of elementary service entities.

10. A service brokering program for providing a complex service integrating a plurality of elementary services realized on a computer, the program causing the computer to execute the functions of:
receiving a request message for the complex service from the outside; and
upon receipt of the request message, decomposing the complex service into the elementary services using service description information comprising a combination of identification information of elementary service entities, declarative description information on information needed to realize the elementary services, and declarative description information on the processing results of the elementary services that are stored in advance for each elementary service, and generating an elementary service request plan comprising strings of combinations of at least elementary service request information needed to realize the complex service, and identification information of the elementary service entities.

11. A computer readable storage medium controlling a computer for providing a complex service integrating a plurality of elementary service by:
receiving a request message for the complex service from the outside; and
upon receipt of the request message, decomposing the complex service into the elementary services using service description information comprising a combination of identification information of elementary service entities, declarative description information on information needed to realize the elementary services, and declarative description information on the processing results of the elementary services that are stored in advance for each elementary service, and generating an elementary service request plan comprising strings of combinations of at least elementary service request information needed to realize the complex service, and identification information of the elementary service entities.

12. A service integration system comprising:
a user agent;
a brokering agent; and,
elementary service agents, connected to each other via a network, for providing a complex service integrating a plurality of elementary services realized on computers,
the brokering agent comprising means for storing service description information comprising a combination of identification information of elementary service entities, declarative description information needed to realize the elementary services, and declarative description information on the processing results of the elementary services,
means for transmitting and receiving messages, and
means for, upon receipt of a request message for the complex service from the user agent, decomposing the complex service into the elementary services using the service description information, and generating an elementary service request plan comprising strings of combinations of at least elementary service request information needed to realize the complex service, and the identification information of the elementary service entities, and
means for requesting elementary services to the elementary service agents based on the generated request plan, and compiling the processing results so that the processing results of the complex service are prepared and notified to the requesting user agent.

13. A service integration system comprising:
a user agent;
a brokering agent; and,
elementary service agents, connected to each other via a network, for providing a complex service integrating a plurality of elementary services realized on computers,
the brokering agent comprising means for storing service description information comprising a combination of identification information of elementary service entities, declarative description information needed to realize the elementary services, and declarative description information on the processing results of the elementary services,
means for transmitting and receiving messages,
means for, upon receipt of a request message for the complex service from the user agent, decomposing the complex service into the elementary services using the service description information, and generating an elementary service request plan comprising strings of combinations of at least elementary service request information needed to realize the complex service, and the identification information of the elementary service entities, and
means for notifying the generated request plan to the requesting user agent,
the user agent comprising means for requesting elementary services to the elementary service agents based on the request plan generated by the brokering agent.
